(19) United States
(12) Patent Application Publication
(10) Pub. No.: US 2008/0307419 A1
(43) Pub. Date: Dec. 11, 2008

(54) Lazy kernel thread binding

(75) Inventors: Matthew D. Klein, Seattle, WA (US); Paul England, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/810,649

(22) Filed: Jun. 6, 2007

(51) Int. Cl. G06F 9/46

(52) U.S. Cl. 718/102

(57) ABSTRACT

Various technologies and techniques are disclosed for providing lazy kernel thread binding. User mode and kernel mode portions of thread scheduling are decoupled so that a particular user mode thread can be run on any one of multiple kernel mode threads. A dedicated backing thread is used whenever a user mode thread wants to perform an operation that could affect the kernel mode thread, such as a system call. For example, a notice is received that a particular user mode thread running on a particular kernel mode thread wants to make a system call. A dedicated backing thread that has been assigned to the particular user mode thread is woken. State is shuffled from the user mode thread to the dedicated backing thread using a state shuffling process. The particular kernel mode thread is put to sleep. The system call is executed using the dedicated backing thread.

### BACKGROUND

Over time, computer hardware has become faster and more powerful. For example, computers of today can have multiple processor cores that can operate in parallel. Programmers would like for different pieces of the program to execute in parallel on these multiple processor cores to take advantage of the performance improvements that can be achieved. A high performance parallel application must exert careful control over its execution to optimize the use of hardware caches and interconnects.

However, operating systems of today are limited in their ability to allow applications to control scheduling of their threads. For example, some operating systems of today, such as MICROSOFT® WINDOWS® support two ways for allowing applications to schedule their own execution. The first way is that an application can adjust its thread state (runnable or suspended), the thread priority, etc. However, the time it takes to put one thread to sleep and start another one using this approach is relatively expensive. Furthermore, a user mode thread can only execute on its associated kernel thread. This makes it difficult to use threads to control application execution in parallel and/or other applications.

The second way an application can schedule its own execution is to use fibers. A fiber is a lightweight execution context that can be scheduled entirely in user mode. However, most operating system services are built around threads as opposed to fibers, and these system services are hard to use or do not work at all when called from fibers. Thus, fibers are also difficult to use in controlling application execution in parallel and/or other operations.

### SUMMARY

Various technologies and techniques are disclosed for providing lazy kernel thread binding. User mode and kernel mode portions of thread scheduling are decoupled so that a particular user mode thread can be run on any one of multiple kernel mode threads. In one implementation, each user mode thread is given a dedicated backing thread. A respective dedicated backing thread is used whenever a user mode thread wants to perform an operation that could affect the kernel mode thread, such as a system call. For example, a notice is received that a particular user mode thread running on a particular kernel mode thread wants to make a system call. A dedicated backing thread that has been assigned to the particular user mode thread is woken. State is shuffled from the user mode thread to the dedicated backing thread using a state shuffling process.

In one implementation, the state shuffling process begins upon receiving notice that a particular user mode thread running on a particular kernel mode thread wants to make a system call. A register state of the particular user mode thread is saved. The particular kernel mode thread is put to sleep. A respective backing thread is woken that was assigned to the particular user-mode thread. The register state is restored to the respective backing thread. The system call is executed using the dedicated backing thread.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a lazy kernel thread binding application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the more detailed stages involved in using dedicated backing threads for system calls for a user mode thread running on a kernel mode thread.

FIG. 5 is a process flow diagram for one implementation of the system of FIG. 1 illustrating the stages involved in shuffling state from a user mode thread running on a kernel mode thread to a backing thread.

FIG. 6 is diagram illustrating how a user mode thread running on a kernel mode thread is transitioned to a dedicated backing thread when a system call is made.

FIG. 7 is a process flow diagram for one implementation of the system of FIG. 1 that illustrates the stages involved in handling subsequent user mode thread executions.

FIG. 8 is a process flow diagram for one implementation of the system of FIG. 1 that illustrates the stages involved in providing thread affinity when using lazy kernel thread binding.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that enhances operating system thread scheduling, but the system also serves other purposes in addition to these. In one implementation, one or more of the techniques described herein can be implemented as features within an operating system program such as MICROSOFT® WINDOWS®, or from any other type of program or service that manages and/or executes threads.

In one implementation, a system is provided that decouples user mode and kernel mode portions of thread scheduling so that a particular user mode thread can be run on any one of multiple kernel mode threads. Each user mode thread is assigned a respective dedicated backing thread. A respective dedicated backing thread is used whenever a particular user mode thread wants to perform an operation that could affect the kernel mode thread, such as a system call. A state shuffling process is used to shuffle state from the user mode thread running on the kernel mode thread to the dedicated backing thread, and then the dedicated backing thread is then used to make the system call.

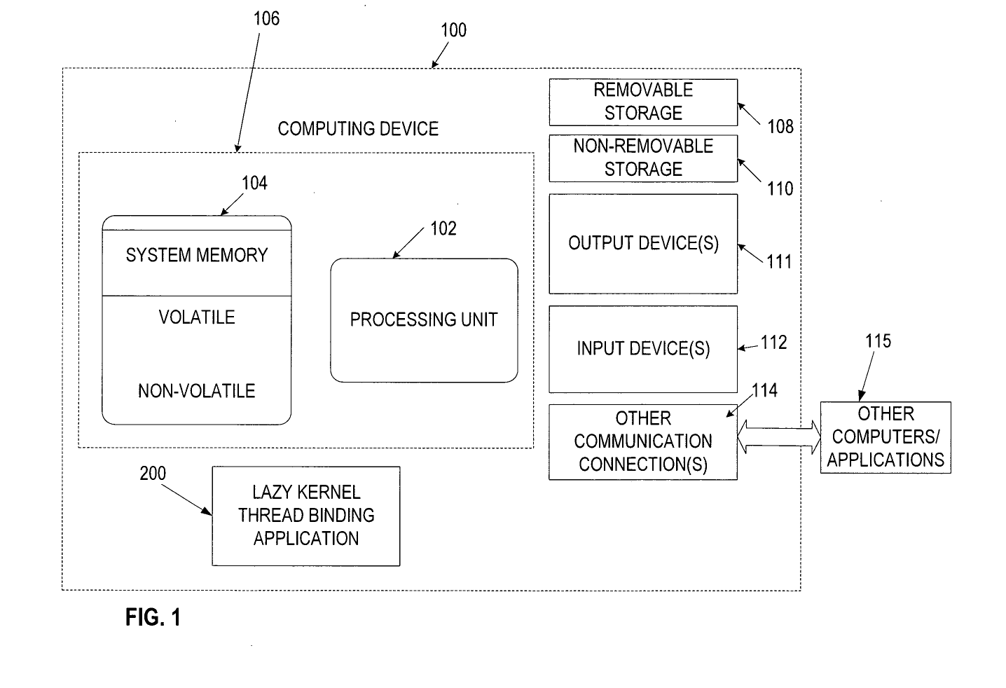

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

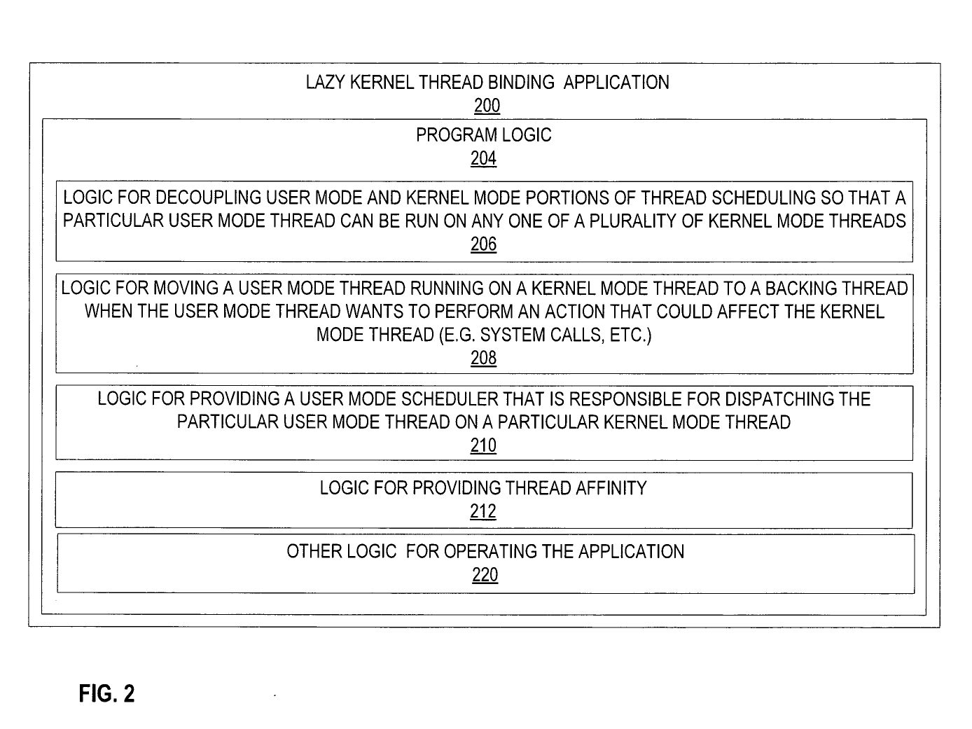

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes lazy kernel thread binding application 200. In one implementation, lazy kernel thread binding application can be part of an operating system executing on computing device 100 or some other application. Lazy kernel thread binding application 200 will be described in further detail in FIG. 2.

Turning now to FIG. 2 with continued reference to FIG. 1, a lazy kernel thread binding application 200 operating on computing device 100 is illustrated. Lazy kernel thread binding application 200 is one of the application programs that reside on computing device 100. However, it will be understood that lazy kernel thread binding application 200 can alternatively or additionally be embodied as computer-executable instructions on one or more computers and/or in different variations than shown on FIG. 1. Alternatively or additionally, one or more parts of lazy kernel thread binding application 200 can be part of system memory 104, on other computers and/or applications 115, or other such variations as would occur to one in the computer software art.

Lazy kernel thread binding application 200 includes program logic 204, which is responsible for carrying out some or all of the techniques described herein. Program logic 204 includes logic for decoupling user mode and kernel mode portions of thread scheduling so that a particular user mode thread can be run on any one of a plurality of kernel mode threads 206; logic for moving a user mode thread running on a kernel mode thread to a dedicated backing thread when the user mode thread wants to perform an action that could affect the kernel mode thread (e.g. system calls, etc.) 208; logic for providing a user mode scheduler that is responsible for dispatching the particular user mode thread on a particular kernel mode thread 210; logic for providing thread affinity 212; and other logic for operating the application 220. In one implementation, program logic 204 is operable to be called programmatically from another program, such as using a single call to a procedure in program logic 204.

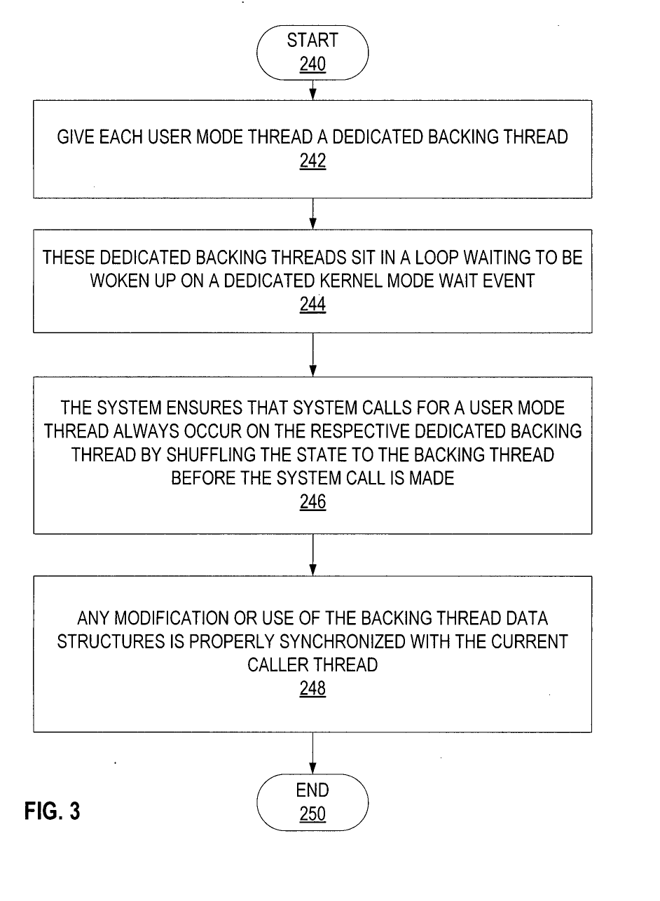

Turning now to FIGS. 3-8 with continued reference to FIGS. 1-2, the stages for implementing one or more implementations of lazy kernel thread binding application 200 are described in further detail. FIG. 3 is a high level process flow diagram for lazy kernel thread binding application 200. In one form, the process of FIG. 3 is at least partially implemented in the operating logic of computing device 100. The process begins at start point 240 with giving each user mode thread a dedicated backing thread (stage 242). In one implementation, the dedicated backing thread is also a kernel mode thread. These dedicated backing threads sit in a loop waiting to be woken up on a dedicated kernel mode wait event (stage 244). The system ensures that system calls for a user mode thread (or other actions affecting the kernel mode thread) always occur on the respective dedicated backing thread by shuffling the state to the backing thread before the system call is made (stage 246). Any modification or use of the backing thread data structure is properly synchronized with the current caller thread (stage 248). The process ends at end point 250.

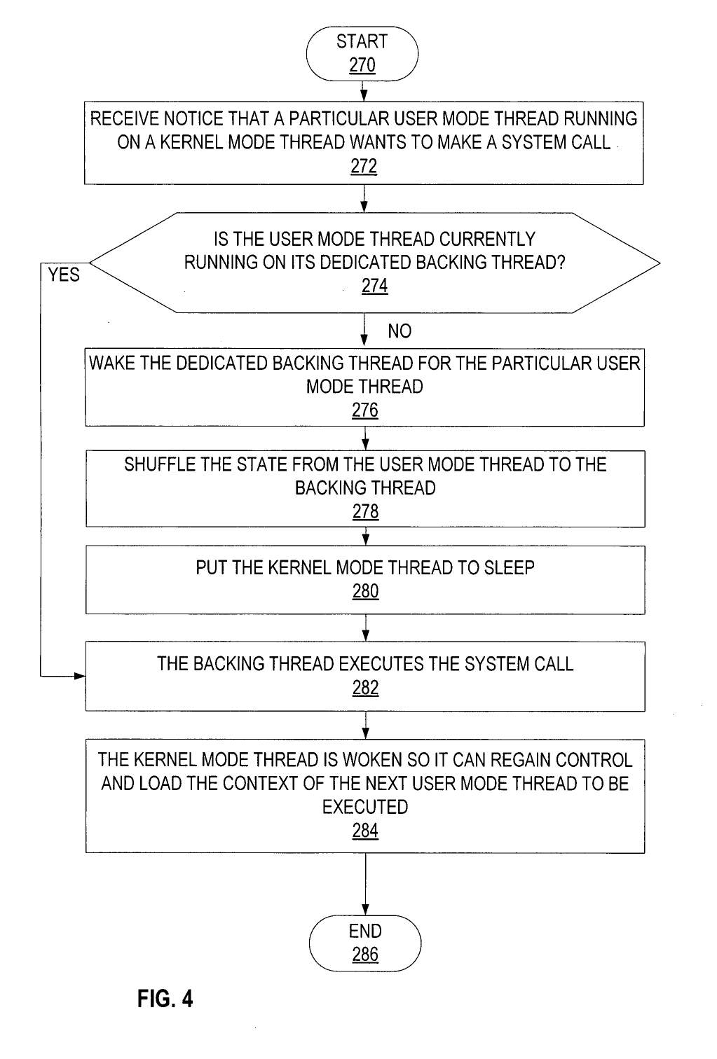

FIG. 4 illustrates one implementation of the more detailed stages involved in using dedicated backing threads for system calls for a user mode thread running on a kernel mode thread. In one form, the process of FIG. 4 is at least partially implemented in the operating logic of computing device 100. The process begins at start point 270 with receiving notice that a particular user mode thread running on a kernel mode thread wants to make a system call (stage 272). If the user mode thread is currently running on its dedicated backing thread, then the backing thread executes the system call (stage 282). If, however, the user mode thread is not currently running on its dedicated backing thread (decision point 274), then the dedicated backing thread for the particular user mode thread is woken (stage 276), state is shuffled from the user mode thread to the backing thread (stage 278), and the kernel mode thread is put to sleep (stage 280). The backing thread then executes the system call (stage 282). In either case, after the backing thread executes the system call (stage 282), the kernel mode thread is then woken so it can regain control and load the context of the next user mode thread to be executed (stage 284). The process then ends at end point 286.

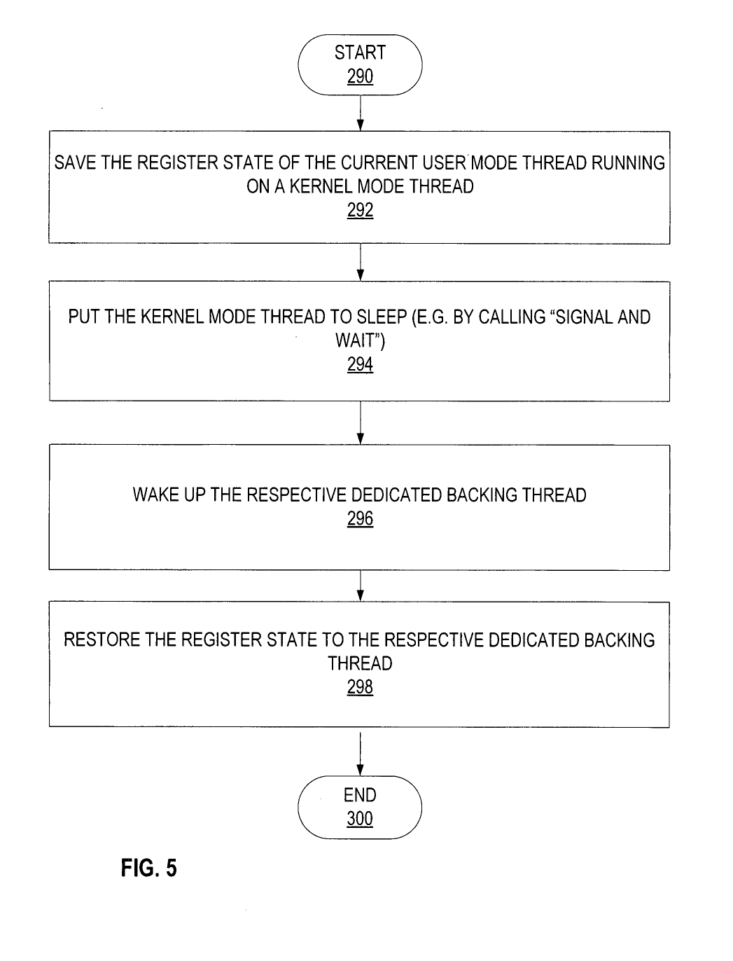

FIG. 5 illustrates one implementation of the stages involved in shuffling state from a user mode thread running on a kernel mode thread to a backing thread. In one form, the process of FIG. 5 is at least partially implemented in the operating logic of computing device 100. The process begins at start point 290 with the system saving the register state of the current user mode thread running on the kernel mode thread (stage 292). The system puts the kernel mode thread to sleep (e.g. by calling “signal and wait”) (stage 294). The system wakes up the respective dedicated backing thread (stage 296) and restores the register state to the respective dedicated backing thread (stage 298). The process ends at end point 300.

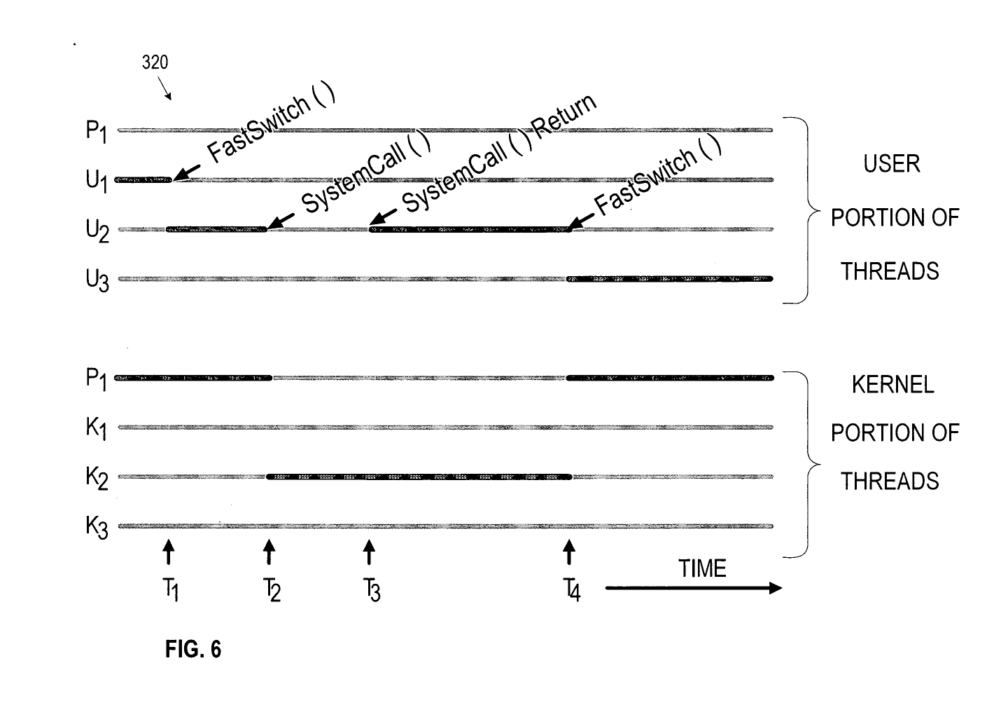

FIG. 6 is a diagram 320 illustrating how a user mode thread running on a kernel mode thread is transitioned to a dedicated backing thread when a system call is made. The figure shows execution flow as a function of time for three user-schedulable threads. U₁-U₃ are the user mode threads, and K₁-K₃ are the kernel mode threads. P is the “primary” kernel mode thread. The darker line shows the running user and kernel threads as a function of time. At T₁ the application calls a “fast switch to thread” routine and the runtime simply switches the user mode thread without changing which kernel mode thread is running. At T₂, the application makes a system call. Now the user mode thread is running on the wrong kernel mode thread so the system puts P₁ to sleep, wakes up K₂ (the backing thread for U₂), transfers context to it and runs the system call on K₂. At T₃, the system call returns.

In one implementation, when the system call is completed, execution is moved back to the kernel mode thread. The backing thread waits so that if this or another kernel mode thread dispatches U₂, the backing thread will be ready to run system calls. In another implementation, which is an optimization that is shown in FIG. 6, the user mode thread can continue to run on its backing thread. Then, at T₄, the application calls the “fast switch to thread” routine and execution is moved back to the kernel mode thread. The backing thread waits so that if this or another kernel mode thread dispatches U₂, the backing thread will be ready to run system calls.

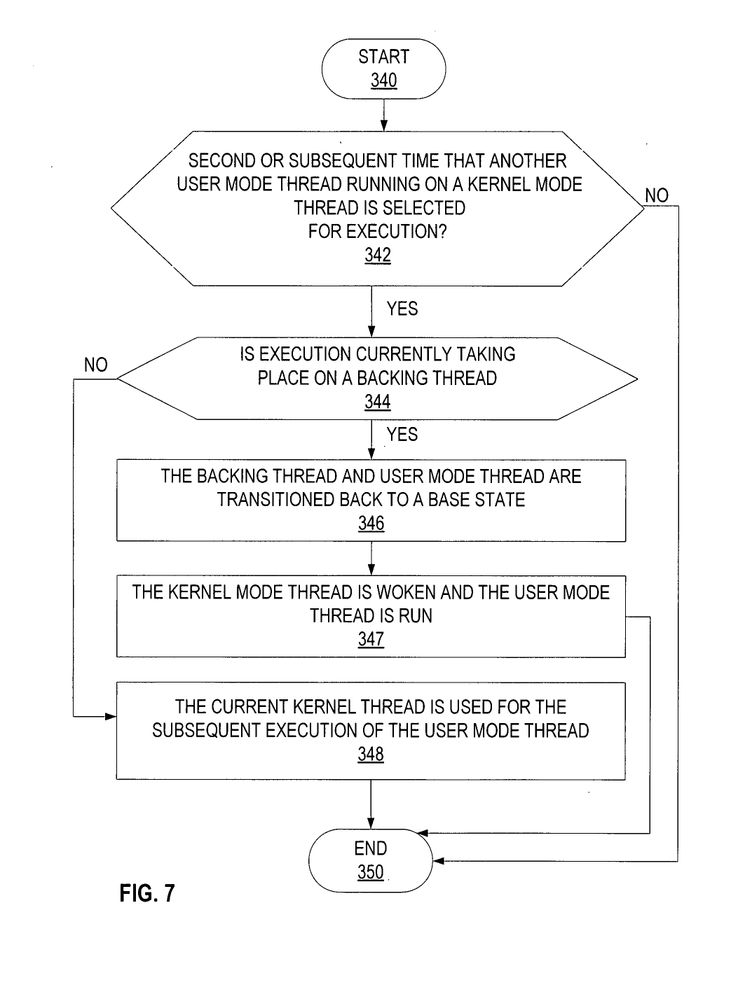

FIG. 7 illustrates one implementation of the stages involved in handling subsequent user mode executions. In one form, the process of FIG. 7 is at least partially implemented in the operating logic of computing device 100. The process begins at start point 340 with determining whether it is the second or subsequent time that another user mode thread running on a kernel mode thread is selected for execution (e.g. of a system call or otherwise) (decision point 342). If not, then the process ends at end point 350. If this is the second or subsequent time, then the system determines if the execution is currently taking place on a backing thread (decision point 344). If execution is not currently taking place on a backing thread (decision point 344), then the current kernel thread is used for the subsequent execution of the user mode thread (stage 348). If however, the execution is currently taking place on a backing thread (decision point 344), then the backing thread and user mode thread are transitioned back to a base state (stage 346), the kernel mode thread is woken, and the user mode thread is run (stage 347). The process ends at end point 350.

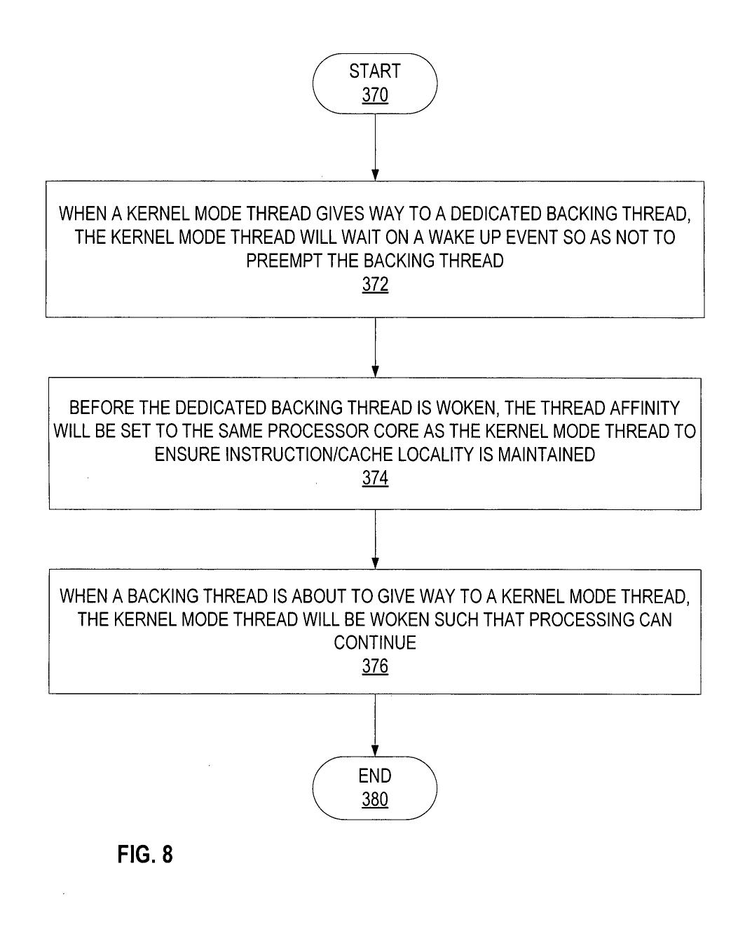

FIG. 8 illustrates one implementation of the stages involved in providing thread affinity when using lazy kernel thread binding. In one form, the process of FIG. 8 is at least partially implemented in the operating logic of computing device 100. The process begins at start point 370 with having the kernel mode thread wait on a wake up event so as not to preempt the backing thread whenever a kernel mode thread gives way to a dedicated backing thread (stage 372). Before the dedicated backing thread is woken, the thread affinity will be set to the same processor core as the kernel mode thread to ensure instruction/cache locality is maintained (stage 374). When a backing thread is about to give way to a kernel mode thread, the kernel mode thread will be woken such that processing can continue (stage 376). The process ends at end point 380.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
decouple user mode and kernel mode portions of thread scheduling so that a particular user mode thread can be run on any one of a plurality of kernel mode threads.

2. The computer-readable medium of claim 1, wherein a user mode scheduler is responsible for dispatching of the particular user mode thread on a particular kernel mode thread of the plurality of kernel mode threads.

3. The computer-readable medium of claim 1, wherein when the particular user mode thread running on a particular kernel mode thread of the plurality of kernel mode threads wants to perform an action that could affect the particular kernel mode thread, a state shuffling process is performed to shuffle state from the particular user mode thread to a respective dedicated backing thread.

4. The computer-readable medium of claim 3, wherein the action is a system call.

5. The computer-readable medium of claim 3, wherein the state shuffling process is operable to save a register state of the particular user mode thread.

6. The computer-readable medium of claim 5, wherein the state shuffling process is further operable to restore the register state to the respective dedicated backing thread.

7. The computer-readable medium of claim 6, wherein the state shuffling process is further operable to put the particular kernel mode thread to sleep.

8. The computer-readable medium of claim 7, wherein the state shuffling process is further operable to wake up the respective dedicated backing thread.

9. A method for using a dedicated backing thread for a system call for a user mode thread running on a kernel mode thread comprising the steps of:
receiving notice that a particular user mode thread running on a particular kernel mode thread wants to make a system call;
waking a dedicated backing thread that has been assigned to the particular user mode thread;
shuffling state from the user mode thread to the dedicated backing thread;
putting the particular kernel mode thread to sleep; and
executing the system call using the dedicated backing thread.

10. The method of claim 9, wherein the waking, shuffling, and putting stages are only performed if the user-mode thread is not already running on the dedicated backing thread.

11. The method of claim 9, further comprising:
waking the particular kernel mode thread so the particular kernel mode thread can regain control.

12. The method of claim 9, wherein the particular kernel mode thread will remain asleep until receiving a waking event so as not to preempt the backing thread.

13. The method of claim 9, wherein before the backing thread is woken, setting a thread affinity to a same processor core as the particular kernel mode thread.

14. The method of claim 13, wherein the thread affinity is set to the same processor to ensure that instruction and cache locality is maintained.

15. The method of claim 9, wherein on a subsequent time that a subsequent user mode thread is selected for execution, and execution is currently taking place on a particular corresponding backing thread, the particular corresponding backing thread and subsequent user mode thread are transitioned to a base state, the particular kernel mode thread is woken, and the subsequent user mode thread is run.

16. A computer-readable medium having computer-executable instructions for causing a computer to perform the steps recited in claim 9.

17. A method for shuffling state from a user mode thread running on a kernel mode thread to a backing thread comprising the steps of:
receiving notice that a particular user mode thread running on a particular kernel mode thread wants to make a system call;
saving a register state of the particular user mode thread;
putting the particular kernel mode thread to sleep;
waking up a respective backing thread that was assigned to the particular user-mode thread; and
restoring the register state to the respective backing thread.

18. The method of claim 17, further comprising:
executing the system call using the respective backing thread.

19. The method of claim 18, further comprising:
waking up the particular kernel mode thread so it can regain control.

20. A computer-readable medium having computer-executable instructions for causing a computer to perform the steps recited in claim 17.
